(19) United States
(12) Patent Application Publication
(10) Pub. No.: US 2009/0094159 A1
(43) Pub. Date: Apr. 9, 2009

(54) STOCK VIDEO PURCHASE

(75) Inventors: Ryan B. CUNNINGHAM, San Francisco, CA (US); Eric M. FIXLER, Oakland, CA (US); Michael G. FOLGNER, Burlingame, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/868,133

(22) Filed: Oct. 5, 2007

(51) Int. Cl. H04K 1/00; G06F 3/048; G06Q 30/00; G06Q 40/00

(52) U.S. Cl. 705/51; 705/1; 705/14; 705/35; 715/764

(57) ABSTRACT

A computer enabled method of assembling at least one section of a media object to form an assembled media object is provided. The method includes receiving a segment description that identifies a portion of the media object, generating an assembled media object that includes the portion, providing the assembled media object for subsequent viewing, wherein the segment description is associated with the assembled media object. The media object may include video, audio, a graphical image, vector graphics animation, an online application, or an applet. The assembled media object may be associated with a content user, and the method may further include associating the segment description with a content owner, where the content owner holds rights to the at least one portion, and transferring consideration between the content owner and the content user, where the amount of consideration is based upon a price associated with the at least one portion.

### BACKGROUND

1. Field

The present application relates generally to methods for selecting and purchasing sections of media objects. More specifically, the present application relates to methods for generating new media objects from sections of media objects, and methods for purchasing the new media objects.

2. Related Art

Media objects such as video, audio, photographs, animations, and applications (e.g., Adobe® SWF vector graphics animations or applets) are composed using video editing systems and distributed to viewers over the Internet, television, radio, and other media. Media objects may be owned by a rights holder, e.g., a content owner, such as a person or company who created the media object or acquired the rights to the media object. The rights holder may provide the media object and associated rights, e.g., one-time or repeated display rights for a video, in exchange for payment of a fee.

For example, stock video footage is typically sold or rented using a preset granularity, e.g., 15 minute segments, as specified by the rights holder of the footage, or their agent. If a user wishes to purchase a segment of video footage showing ocean waves, but the desired segment is a 30 second segment within a 15 minute piece of footage, the user of an existing system will have to acquire the rights to the entire 15 minute piece to get rights to the smaller embedded segment. Furthermore, existing video editing and distribution systems often do not provide mechanisms for users to pay the rights holders for videos. Instead, users track their use of a media object and pay the rights holders according to an agreement. The video distribution system typically does not provide assistance in paying the rights holder.

It would be desirable, therefore, to have a media distribution system that provides for purchase of media objects at a desired granularity.

### SUMMARY

In general, in a first aspect, the invention features a computer enabled method of assembling at least one section of at least one first media object to form an assembled media object. The method includes receiving at least one segment description that identifies at least one portion of the at least one first media object, generating an assembled media object that includes the at least one portion, and providing the assembled media object for subsequent viewing, wherein the at least one segment description is associated with the assembled media object.

Embodiments of the invention may include one or more of the following features. The at least one first media object may include video, audio, a graphical image, vector graphics animation, an online application, an applet, or a combination thereof. The at least one first media object may be characterized by a first quality level, and the method may further include generating a preview media object that includes a representation of the at least one portion of the at least one first media object, wherein the preview media object is characterized by a preview quality level, and the preview quality level is lower than the first quality level, and providing the preview media object for presentation to a user. The at least one portion may be defined by a start time within the at least one first media object and an end time within the at least one first media object. The method may further include associating a price with the at least one segment description.

The assembled media object may be associated with a content user, and the method may further include associating the at least one segment description with a content owner, wherein the content owner holds rights to the at least one portion, and transferring consideration between the content owner and the content user, wherein the amount of consideration is based upon the price associated with the at least one portion. The method may be provided by a user interface in a web browser.

In general, in a second aspect, the invention features an interface for creating media objects. The interface includes a presentation component for presenting a first media object, a selection component for selecting at least one portion of the first media object, and an assembly component for generating an assembled media object, wherein the assembly component is operable to include the at least one portion in the assembled media object at a position specified by a user.

Embodiments of the invention may include one or more of the following features. The interface may include a download component for causing the assembled media object to be stored on the user's computer in response to selection by the user of the download component. The interface may include a payment component for receiving consideration for the assembled media object in response to selection by the user of the purchase component, wherein the amount of the consideration is based upon the at least one portion, and the payment component is operable to transfer the consideration between the user and a content owner, wherein the content owner owns the at least one portion. The interface may include a download component for causing the assembled media object to be stored on the user's computer in response to receiving the consideration. The interface may include a purchase component for receiving consideration for rights to the assembled media object in response to selection by the user of the purchase component, wherein the rights entitle a purchaser thereof to use the assembled media object in other media objects. The selection component may be operable to receive a start time and an end time of the at least one portion.

In general, in a third aspect, the invention features a computer program product that includes program code for providing an assembled media object to a user, wherein the assembled media object includes at least one portion of a first media object. The program code is for storing a representation of the assembled media object and associated attributes, receiving consideration for the at least one portion, wherein the amount of the consideration is based upon a price of the at least one portion, transferring the consideration to a content owner associated with the at least one portion from a user associated with the assembled media object, and providing the assembled media object to the user.

In general, in a fourth aspect, the invention features a computer program product that includes program code for allocating payment for presentation of advertisements in media objects. The program code is for storing a representation of at least one assembled media object and associated attributes, wherein the at least one assembled media object includes at least one advertisement portion associated with an advertiser, and transferring consideration from the advertiser to a first user associated with the at least one assembled media object in response to perception of at least a portion of the advertisement portion by a second user, wherein the amount of consideration is based upon a price associated with the at least one advertisement portion. Perception may include viewing, hearing, selection, or a combination thereof. The first user may include a creator of the at least one assembled media object, a holder of rights to the at least one assembled media object, or a combination thereof.

In general, in a fifth aspect, the invention features a computer-enabled method of allocating payment to at least one content owner in a media delivery system. The method includes receiving a request for a media object, wherein the media object includes at least one portion, and the at least one portion is associated with a first price and a first content owner, transferring consideration between a user associated with the media object to the first content owner, wherein the amount of consideration is based upon the first price, and granting the request for the media object. Embodiments of the invention may include one or more of the following features. The method may further include: if the at least one portion includes at least one sub-portion, wherein the sub-portion is associated with a second price and a second content owner, transferring consideration between the user associated with the media object and the second content owner, wherein the amount of consideration is based upon the second price.

### BRIEF DESCRIPTION OF THE DRAWINGS

The present application can be best understood by reference to the following description taken in conjunction with the accompanying drawing figures, in which like parts may be referred to by like numerals:

FIG. 1A is an illustrative drawing of a video assembly system in accordance with some embodiments of the invention.

FIG. 1B is an illustrative drawing of a segment description in accordance with embodiments of the invention.

FIGS. 2 and 3 are illustrative drawings of video assembly user interfaces in accordance with embodiments of the invention.

FIG. 4A is an illustrative drawing of a video assembled from portions of videos in accordance with embodiments of the invention.

FIG. 4B is an illustrative drawing of segment descriptors for an assembled video in accordance with embodiments of the invention.

FIG. 5 is an illustrative flow diagram of a process for assembling a video in accordance with embodiments of the invention.

FIG. 6 is an illustrative drawing of an advertising system in accordance with embodiments of the invention.

FIG. 7 is an illustrative flow diagram of a process for making payments to rights owners of portions in accordance with embodiments of the invention.

FIG. 8 is an illustrative drawing of an exemplary computer system that may be used in accordance with embodiments of the invention.

### DETAILED DESCRIPTION

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

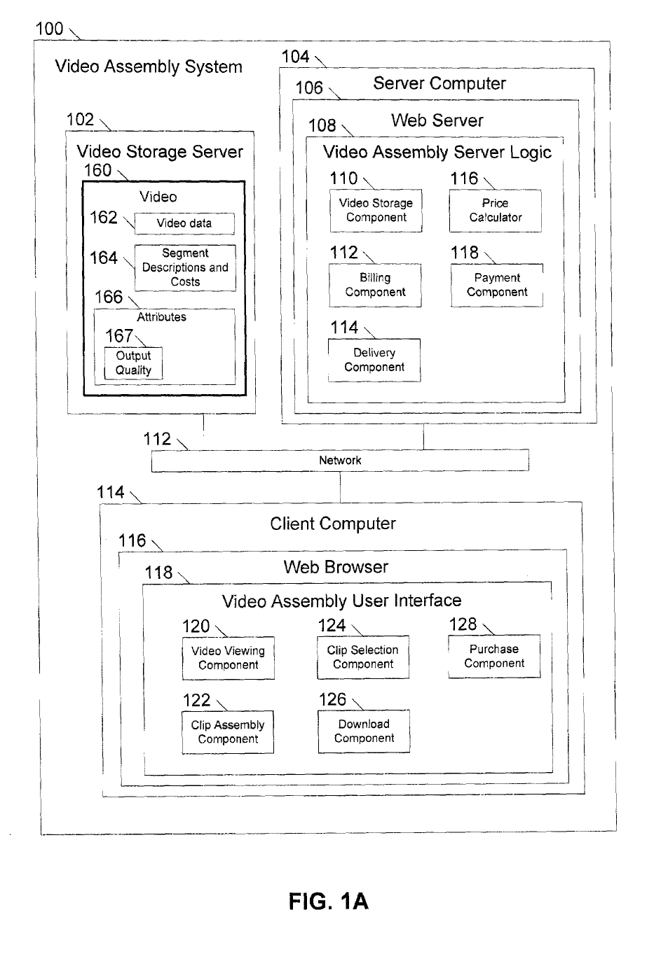

FIG. 1A is an illustrative drawing of a video assembly system 100 in accordance with embodiments of the invention. The video assembly system 100 provides an assembled video, such as a video 160, in the form of segment descriptions 164, to a user (not shown). The assembled video includes one or more portions, i.e., segments or excerpts, of a first video 162. The first video 162 may be, for example, stock video made available by a rights holder for purchase or licensing by other users. The rights holder may be, for example, a content owner, such as a person or company that owns the video. Note that although embodiments are described herein in terms of video, any type of media object may be used, e.g., audio, still graphical images such as photographs, vector animations, applications, and applets, such as Adobe SWF® objects. The system 100 includes a video storage server 102 for storing a representation of the at least one assembled video, e.g., the segment descriptions 164 which define the excerpts, and the first video 162 from which the excerpts are taken. The video storage server 102 also stores attributes 166 of the segment descriptions 164, such as an output quality 167. A server computer 104 executes a web server 106, which in turn executes or communicates with video assembly server logic 108 (e.g., computer program code) to implement back-end portions of the video assembly system 100.

The video assembly server logic 108 communicates with a video assembly user interface 118 (e.g., computer program code) executing on or in conjunction with a web browser 116 which in turn executes on a client computer 114. The communication between the server computer 104 and the client 114 is via a network 112, e.g., the Internet. In some examples, the video storage server 102 and the server computer 104 may be combined on a single computer or server. The video assembly user interface 118 is provided by a server computer 104, e.g., as a web server page transmitted via the communications network to the web browser 116 executing on the client computer 114. The video assembly user interface may be implemented using JavaScript™, HTML, Adobe® Flash®, Java®, or any other programming system for developing server-based user interfaces that interface with users via client computers 114. The video storage server 102 also communicates with the video assembly server logic 108 via the network 112 to retrieve and store video data 162 and associated information such as the segment descriptions and prices 164.

A price 164 may be, for example, a royalty payment amount, to be made in exchange for use of a media object, a purchase payment amount to be made in exchange for ownership of a media object, or any other amount of expected payment.

The video assembly server logic 108 includes a video storage component 110 for communicating a representation of the video 160, including the video data 162, segment descriptions and prices 164, and attributes 166, from the server computer 104 to the video storage server 102 for storage. The video assembly server logic 108 also includes a price calculator 116 for determining a price of the assembled video 160. The price of the assembled video is calculated based upon a price associated with the segment description 164 for each portion, i.e., segment, of the assembled video 160. In one example, the price of the assembled video 160 is the sum of the prices of the portions. A billing component 112 requests payment of the price of the assembled video, e.g., by requesting credit card or other account information from a user in accordance with the license or sales terms of each portion used in the assembled video. The payment may be a transfer of consideration from the user to the rights holder. The consideration may take the form of an online payment, a credit toward future purchases, or the like, or any other act.

The video assembly server logic 108 also includes a payment component 118 for allocating payment to the rights holder associated with each portion of the video 160 in response to delivery of the assembled video to the user. The amount of payment to the rights holder is based upon the price associated with each portion. The total price of the assembled video 160 may be paid to the video assembly system 100, in which case the system 100 distributes money to the rights holders of the portions. In another example, the system 100 may enable the user to pay the rights holders directly, e.g., by accepting or deducting payment from the user for each portion, and transferring the payments directly to the rights holders of the corresponding portions.

In one example, an assembled video may include a portion associated with a rights holder and a price, and that portion may in turn include another portion, i.e., a sub-portion, associated with a rights holder and a price, and so on, essentially to any number of nested rights holders. When payment is made for a first portion, each rights holder associated with the first portion is paid according to the price associated with the first portion, and the payment is performed recursively for each sub-portion included in the first portion, if the first portion includes any sub-portions.

A delivery component 114 provides the assembled video to a user, e.g., by transmitting or streaming the video across the network 112 to a download component 126 on the client computer 114. In another example, the delivery component 114 may make the assembled video 160 available for subsequent viewing and/or download in by the user who created the video and provided billing information.

In one example, the assembled video may include an advertisement portion, and payment of the price of the advertisement portion may be made to the rights holder of the advertisement portion in response to use of the assembled video. Possible uses of a video include display of the video, viewing of the video, selection of or clicking on the video on a web page, or selection of a web link associated with the video.

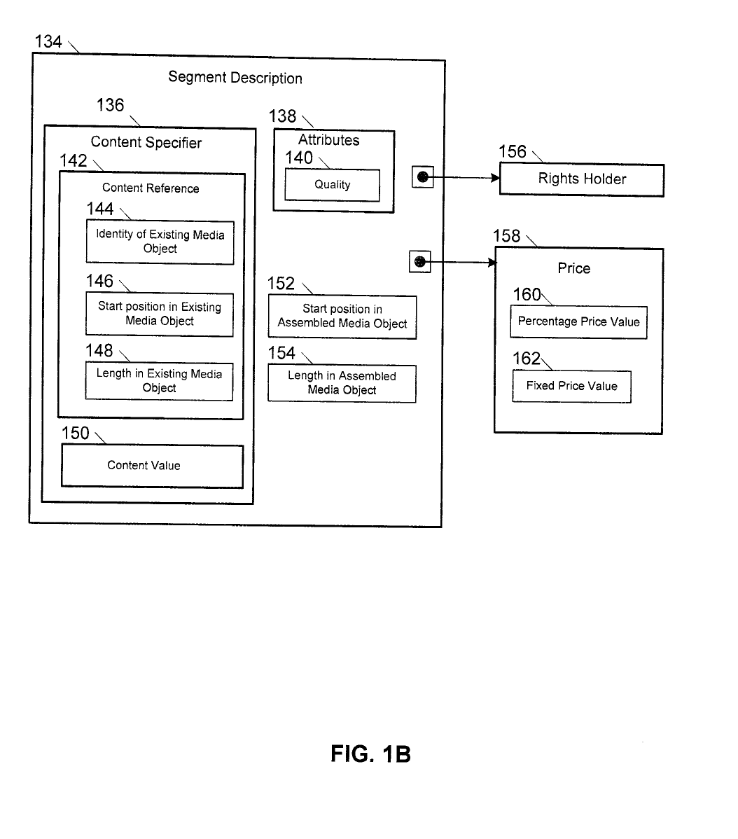

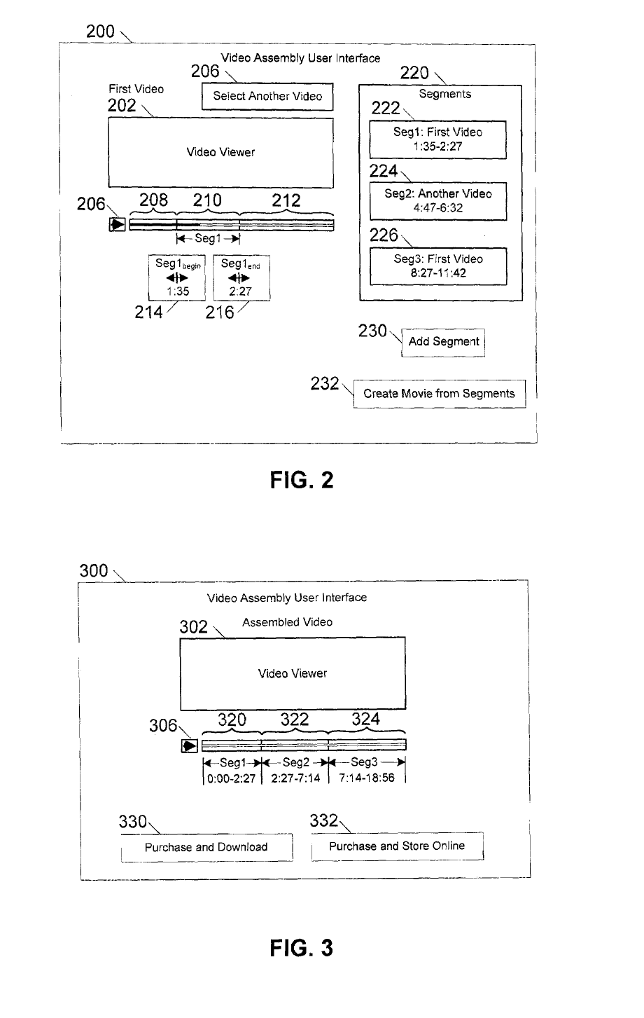

The video assembly user interface 118 is shown as a component presented in a web browser 116, although in other examples the user interface 118 may be presented as another type of application independent of a web browser. The user interface 118 includes a video viewing component 120 which displays the video 160 and excerpts of videos (not shown). A clip selection component 124 allows the user to select the segments of the clips to be included in the assembled video 160, and a clip assembly component 122 allows a user to position the segments within the assembled video 160. The download component 126 allows a user to download the assembled video to the client computer 114. A purchase component 128 interacts with the user to gather purchase information to be submitted to the server-side billing component 112. These components of the user interface 118 are described in more detail below with respect to FIGS. 2 and 3.

FIG. 1B is an illustrative drawing of a segment description 134 in accordance with embodiments of the invention. The segment description 134 includes a content specifier 136, attributes 138, and a start position 152 and end position 154 in the assembled media object. The content specifier 136 identifies a portion, i.e., segment, of the video. In particular, the content specifier 136 may include a content reference 142, which identifies the portion by reference to the video, or a content value 150, which is a value, e.g., video file or other content object or media object, in which the content is stored. Either the content reference 142 or the content value 150 may be present, but both will generally not be present in the same content specifier 136. The reference 142 allows the media object (e.g., source video) to be used, but depends on the media object remaining available, whereas the value 150 is typically a copy of the media object and therefore uses more resources, but does not rely on the media object remaining available. When the content reference 142 is used, an identity 144 of the media object is stored in the content reference 142 along with a start position 146 and an end position 148 relative to the beginning of the media object. When the value 150 is used, the start and end positions and the identity of the content or media object need not be stored and are not shown with the content value 150, although they may be stored if desired.

The segment description 134 may be associated with a rights holder 156, which is an entity such as a person or company that owns rights to the segment represented by the segment description 134. A price 158 may be associated with the segment description 134. The price is an amount of money or other form of payment to be made by the user of the segment to the rights holder 156. The price 158 may be a percentage price value 160, e.g., 10% of the revenue generated by an assembled video that includes the segment. The price may also include a fixed price value 162, e.g., $1 for one use of the segment. The type and amount of the price 158 may be negotiated by the user and the rights holder, or may be specified by the rights holder, or may be determined by an auction, or may be based upon demand for the segment.

FIG. 2 is an illustrative drawing of a video assembly user interface in accordance with embodiments of the invention. FIG. 2 shows components of the video assembly user interface that allow a user to assemble portions of one or more videos 202 to create an assembled video 302 (shown in FIG. 3). The components include user interface controls, such as a video viewer, a play/pause button 206 and a slider for controlling the display of the video, buttons for receiving other control input from a user, and text labels for displaying information. The components may also include computer program code that performs actions based on the user's interactions with the components. As described above, in one example, the components are provided to the client 114 by a server 104. The video assembly user interface 200 displays the video 202 in the video viewer such as, for example, an Apple® QuickTime® plug-in in a web browser. The play button 206 allows the user to start and stop the video. A linear representation of the video may be divided into segments. In this example the linear representation is shown as a horizontal bar graph. The bar graph is divided into three segments 208, 210, 212. The middle segment 210 is named Seg1. The middle segment has been created by a user's selection of an add segment button 230, which causes a segment begin marker 214 and a segment end marker 216 to be displayed in association with the segment begin and end points. The user may move the segment begin marker 214 to the left and right to adjust the start time of the segment. In this example, the segment begin marker 214 has been moved to a position that corresponds to 1 minute and 35 seconds from the beginning of the video. The segment end marker 216 has been moved to a position that corresponds to 2 minutes and 27 seconds from the beginning of the video. A segment 210 is thereby defined and is given a default name Seg1. Two other segments 208, 212 are implicitly created and are given default names as well, e.g., Seg2 and Seg3.

A segment 210 may be selected by clicking on the horizontal graph between the begin and end markers 214, 216 that correspond to the desired segment. The begin and end times of the segment 210 may then be adjusted by moving the begin marker 214 and the end marker 216. More segments may be defined by selecting the Add Segment button 230, in which case additional begin and end markers may appear, and the bar graph may be divided into additional segments. A different source video may be selected using the Select Another Video button 206. The segments are displayed in a segments list 220, which includes three segment entries in this example. A first segment entry 222 indicates that Seg1 is an excerpt from a video named “First Video” and Seg1 runs from 1:35 to 2:27 in “First Video.” A second segment entry 224 indicates that Seg2 is an excerpt from a video named “Another Video” and runs from 4:47 to 6:32 in “Another Video.” A third segment entry 226 indicates that Seg3 is an excerpt from “First Video” and runs from 8:27 to 11:42 in “First Video.” The example in segments list 220 shows the segments selected for the assembled video in chronological order. A user may reorder the segments for the assembled video by dragging the entries in the segment list 220. The horizontal bar graph shows the selectable segments in a representation of a video.

Once the user has added all desired segments to the segments list 220, the user may select the Create Movie button 232 to generate an assembled video that includes the selected segments in the order shown in the segments list 220. After the Create Movie button 232 has been selected, the assembled video is presented in the video assembly user interface for purchase and/or download.

FIG. 3 is an illustrative drawing of a video assembly user interface 300 in accordance with embodiments of the invention. FIG. 3 shows features of the video assembly user interface 300 that allow a user to purchase rights to portions of videos that have been used in creating an assembled video. The assembled video is displayed in a viewer 302, and may be previewed, e.g., a low quality, such as lower resolution and/or lower frame rate than the actual assembled video. A play button 306 may be selected to display the preview in the viewer 302. A horizontal bar graph represents the assembled video and is divided into segments 320, 322, 324 that correspond to the segments of the video. The first segment 320 runs from the beginning of the assembled video to 2:27. The second segment 322 runs from 2:27 to 7:14. The third segment 324 runs from 7:14 to 18:56.

In one example, a user may purchase the assembled video, or rights to it, by selecting a Purchase and Download button 330, in which case the user interface 300 may request payment information from the user, such as a payment account number. The actual transfer of funds may occur prior to or at the time of download of the video, or may occur when the assembled video is displayed. The user may prefer to store the video online, e.g., in an account on the video assembly system, instead of downloading the video, in which case the user may select the Purchase and Store Online button 332. The assembled video will be stored in an area, e.g., at a URL or web site address, accessible to the user. Whenever the assembled video is viewed, a payment may be made to the rights holder of each portion in the amount specified by the price associated with the portion.

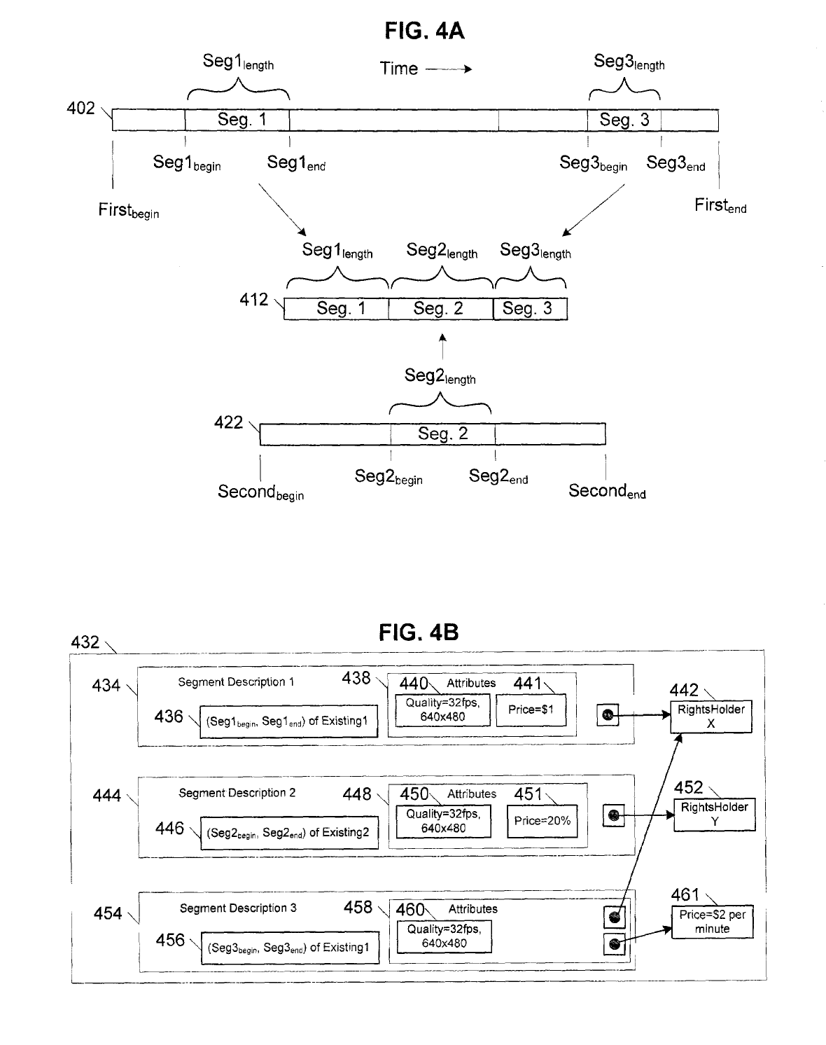

FIG. 4A is an illustrative drawing of a video assembled from portions of videos in accordance with embodiments of the invention. FIG. 4A shows a logical representation of an assembled video 412, which includes a first segment, Seg 1, a second segment, Seg 2, and a third segment, Seg 3. In other examples, the assembled video 412 may include any number of segments or clips from any number of videos, such as stock videos, and may also include newly-created video. Each segment is a portion, i.e., excerpt, of a video. Each segment is defined by a position in the video and a length that extends relative to the position. For example, Seg 1 is defined by a position Seg1begin and a length Seg1length in the first video 402. Seg1begin is a time value relative to the beginning of the beginning of the first video 402. The position and length (or start position and stop position) may be specified using any appropriate metrics. The length may be specified implicitly if the segment is specified as a start position and an end position. In one example, a segment is a video clip specified by a start time in hours, minutes, and seconds, and a length in hours, minutes and seconds, where the clip is located in another video (also referred to herein as a first video) at the specified start time relative to the beginning of the first video, and the clip extends continuously from the start time for an amount of time defined by the length. Seg 2 is a section of the second video 422. Seg 2 begins at Seg2begin and ends at Seg2end in the second video 422. Seg 3 begins at Seg3begin and ends at Seg3end in the first video 402.

The assembled video 412 includes three portions of other videos. The three portions are Seg 1, Seg 2, and Seg 3. In other examples, the assembled video 412 may include original portions (i.e., clips) that are not excerpts of other videos. Original portions are typically provided by the user who generates the assembled video 412. Excerpt portions, such as Seg 1, Seg 2, and Seg 3, may be excerpts of videos created by another user, in which case the user who uses the excerpts may be expected to pay fees or royalties for the use of the excerpts. The excerpt portions, e.g., Seg 1, Seg 2, and Seg 3, may be excerpts of other videos created by the same user, i.e., a user may assemble videos from clips of other videos that the same user has created, in which case the user would not be expected to pay for the use of the excerpts unless the excerpts themselves were assembled from clips for which fees or royalties are expected.

In the example shown in FIG. 4A, the portions Seg 1, Seg 2, and Seg 3 are included in the assembled video 412. The video 412 begins with Seg 1, which is the portion of the first video 402 starting at Seg1begin and extending forward to Seg1end, i.e., extending for Seg1length from Seg1begin. The video 412 continues with Seg 2 following Seg 1. The start position of Seg 2 in the video 412 is therefore defined by Seg1length, since Seg 2 immediately follows Seg 1. The video 412 continues with Seg 3 following Seg 2. The start position of Seg 3 in the video 412 is therefore defined by Seg1length+Seg2length.

FIG. 4B is an illustrative drawing of segment descriptors for an assembled video in accordance with embodiments of the invention. FIG. 4B shows segment descriptions 432 that specify the contents of the three-segment assembled video 412. The assembled video 412 may be represented as, for example, a list 432 of segment descriptions 434, 444, 454 that refer to portions, e.g., Seg 1, Seg 2, and Seg 3, of video(s) 402, 422. The segment descriptions 434, 444, 454 are, for example, data structures stored in a computer readable medium. The assembled video 412 may be, for example, a file that contains copies of the video segments (e.g., video files in a format such as QuickTime®), along with the segment descriptions 434, 444, 454 that describe the assembled video 412. In another example, the assembled video 412 does not include copies of the video segments, and instead includes the video files by reference via the segment descriptions 434, 444, 454.

The first segment description 434 corresponds to the segment Seg 1 and includes a content reference 436 that identifies the source video of the first segment as “Existing1”. The content reference 436 also specifies the begin and end times of the first segment relative to the beginning of the source video as Seg1begin and Seg1end, which may be times expressed in seconds. The segment description 434 also includes attributes 438, such as a quality attribute 440 and a price attribute 441. The quality attribute 440 specifies a desired output quality, i.e., resolution and frame rate, for the corresponding segment. Other types of quality attributes may also be included in the attributes 438, such as the quality of the source video, or a minimum or maximum acceptable quality. The price attribute 441 in this example specifies a fixed price, $1, to be paid to the rights holder of the corresponding segment when the segment is used or presented. The price may be established when the segment description 434 is created and may be provided by the rights holder. In another example, the price attribute 441 may be updated over time based upon demand for the segment or fluctuations in the prices of video segments. The segment description 434 is associated with a rights holder 442. The association may be established by a link such as pointer in a data structure, or by a relation such as a relation in a relational database, or by storing a value that identifies the rights holder 442 in the segment description 434. The rights holder 442 identifies a person, company, or other entity to whom payment of the price 441 is to be made when the corresponding segment is used or presented.

Similarly, the second segment description 444 includes a content reference 446 that identifies the source video of the second segment as “Existing2”. The content reference 446 also specifies the begin and end times of the second segment relative to the beginning of the source video as Seg2begin and Seg2end. The second segment description 444 includes a quality attribute 450 and a price 451. The price 451 in this example is specified as a percentage of the price charged by the rights holder of the assembled video 412. The second segment description 444 is also associated with a rights holder 452. In this example, the rights holder 452 has specified that 20% of the revenue received from the assembled video 412 is to be paid to the rights holder 452.

The third segment description 454 includes a content reference 456 that identifies the source video of the third segment as “Existing1”. The content reference 456 also specifies the begin and end times of the third segment relative to the beginning of the source video as Seg3begin and Seg3end. The third segment description 454 includes a quality attribute 460 and is associated with a price 461 by a reference. The third segment description 444 is also associated with the rights holder 442. The price 461 in this example is specified as a per-minute rate of $2 to be paid to the rights holder 442 of the third segment for the time that the third segment is used or presented.

Although FIGS. 4A and 4B are described in terms of video media, the content objects 402, 422 and the assembled object 412 need not be video data. Instead, they may be, for example, audio data, animations, computational applications, or any type of media object that may be defined as a data stream for which a position and a length may be defined, e.g., a stream of bytes.

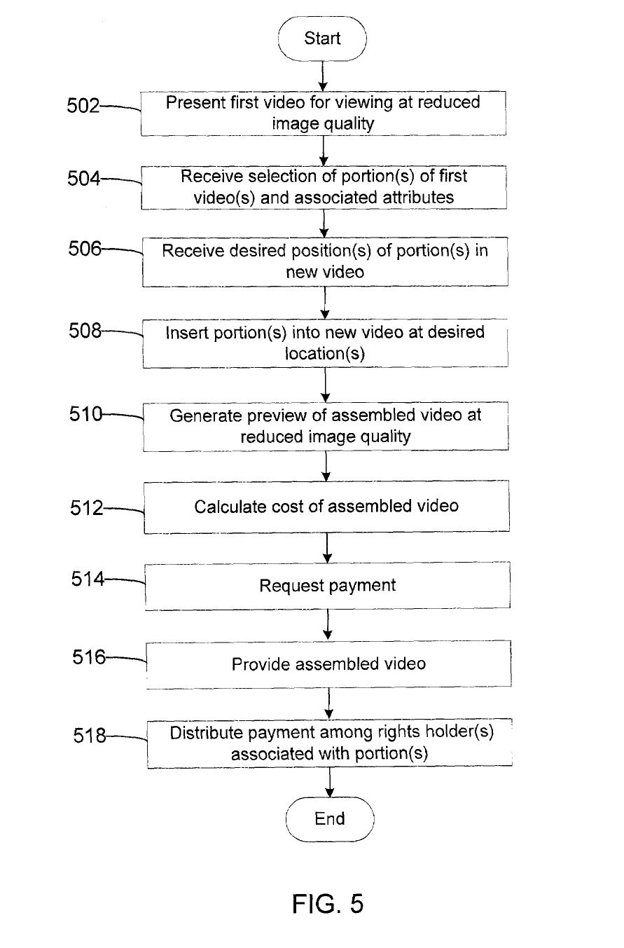

FIG. 5 is an illustrative flow diagram of a process for assembling a video in accordance with embodiments of the invention. The process of FIG. 5 corresponds to the clip assembly component 122 of FIG. 1A and may be provided by, for example, computer program code stored on a computer-readable medium. Block 502 presents a first video for viewing by a user. The first video may be presented at reduced quality for better response times, particularly if the video is being transmitted over a low-bandwidth network connection. The user need not view the video, but may view selected portions of it to select one or more portions. Block 504 receives the user's selection of the portions to be included in the assembled video, and associated attributes such as desired output quality. Block 504 may receive a price of the video if a price has been specified by the user, e.g., in a negotiation with the rights holder. In other examples, the price is provided by the rights holder or by the video assembly system, and is not set by the user who creates the assembled video. Bock 506 receives the desired positions, i.e., order, of the selected portions in the new video. The video assembly user interface allows the user to specify these positions as described above with respect to the segments list 220 of FIG. 2. In one example, the user may also provide their own video segments, or segments not owned by any rights holder. In that case, the segments may be added to the assembled video without an associated rights holder or price. Block 508 inserts the selected portions, and any other video segments selected by the user, into the video at the desired locations, i.e., in the user-specified order. Block 510 generates a preview rendition of the assembled video at a reduced image quality relative to the output quality. The user may view the preview rendition to review or evaluate the assembled video before purchase. Block 512 calculates the price of the assembled video as described above with respect to the price calculator 116 of FIG. 1A. Block 514 requests payment for the assembled video. The payment user interface is described above with respect to the Purchase and Download button 330 of FIG. 3. Block 516 provides the assembled video as described above with respect to the Purchase and Download button 330 of FIG. 3. The actual transfer of funds may occur prior to or at the time of download of the video, or may occur when the assembled video is displayed, and the funds are transferred to the rights holders associated with the videos. Block 518 distributes payment among the rights holders associated with the portions of the assembled video. The payment process is described above with respect to the payment component 118 of FIG. 1A.

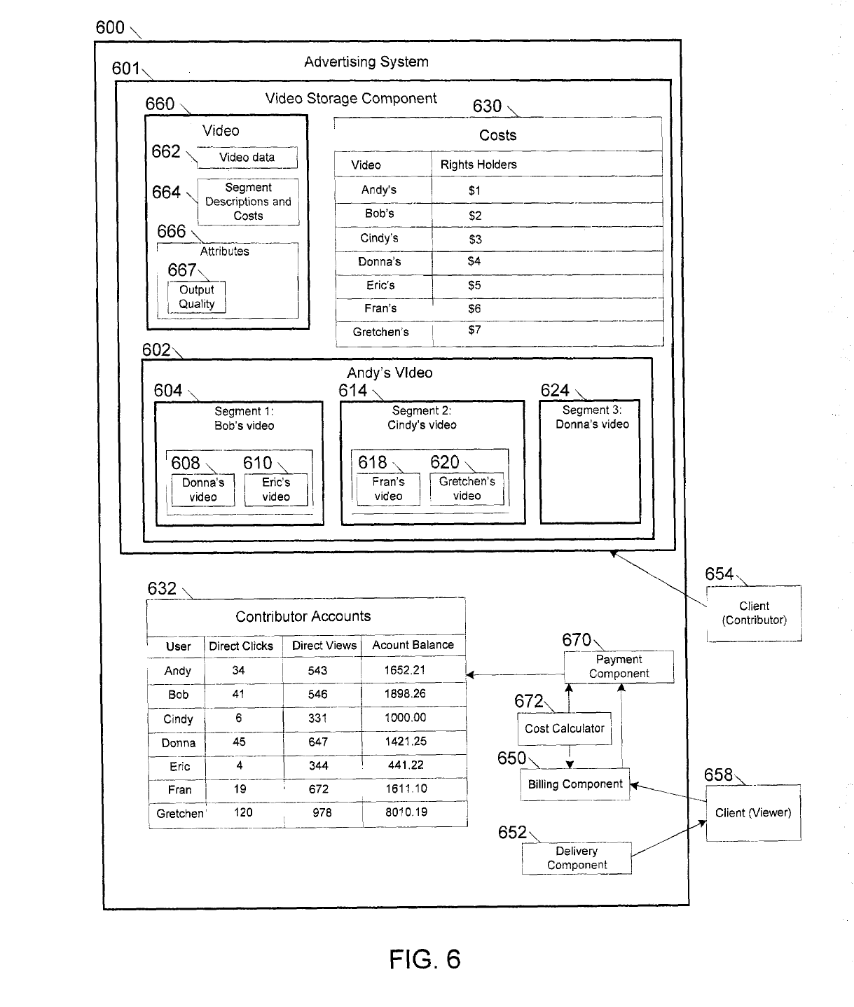

FIG. 6 is an illustrative drawing of an advertising system 600 in accordance with embodiments of the invention. In the advertising system 600, the user who created the assembled video that contains the advertising portion is paid, by an advertiser who provided the advertising portion, when the advertising portion is viewed, in contrast to the payment to rights holders of portions for viewing rights described above with respect to the video assembly system 100 of FIG. 1A. An advertiser may be, for example, a person or company who makes an advertisement, such as a video clip, available for use in videos created by users of the advertisement system. Therefore, each view of a portion in an assembled video 660 results in a transfer of consideration from the advertiser to the user who created the assembled video, e.g., by transferring money from the advertiser's account to the video creator's account. The advertising system 600 is otherwise similar to the video assembly system 100. In one example, each portion of a video in the advertising system 600 is associated with a rights holder, but the rights holder is an advertiser who pays for the use of the portion instead of a content provider who is paid for the use of the portion. Furthermore, each portion is associated with a price, but in the advertising system, the price is paid to the rights holder, and is therefore referred to below as a payment amount.

The advertising system 600 includes a video storage component 601 that receives an assembled video 660 from client contributors 654. The client contributors 654 may provide both first (e.g., stock) videos and assembled videos. Stock videos may be advertisements provided by companies that wish to display the advertisements to viewers such as a client viewer 658. Information about the client contributors 654 is stored in a Contributor Accounts table 632. The table 632 may be a file stored in persistent storage, or a relational database, or data stored in any other format on a computer-readable medium. The Contributor Accounts table tracks the following information for each user who has contributed media content to the advertising system: the number of direct clicks (i.e., clicks on the user's portion(s) of a video while the portion is displayed), direct views (i.e., number of times the user's portion of a video has been viewed), indirect clicks (i.e., number of clicks on other users' portions of a video, where the user does not hold rights to the portion, but does hold rights to some other portion of the video), indirect views (i.e., views of other user's portions of a video to which the user holds rights), and an account balance, which is the total amount of currency that has been deposited in the user's account (since some initial time) as a result of use or viewing of portions of the video for which the user receives payments, minus the total amount withdrawn. In one example, payments are made from the accounts of companies that provide advertisements to the accounts of users who create assembled videos that include the advertisements.

In one example, when a client viewer 658 views a video 660 that includes advertisement portion(s) associated with a payment amount and a rights holder, the identity of the portion(s) is sent to a billing component 650 that deducts the price of the advertisement from the advertiser's account. The advertising system may perform this processing once for all advertising portions in the video before the video is viewed, or for each advertising portion as the portion is displayed while the video is being viewed. The billing component 650 requests the price of the segment or video from the price calculator 672, and any nested advertisements may be included in the price calculation. The billing component 650 may then, for example, request payment from the advertiser, or may proceed to automatically deduct payment from an account associated with the advertiser. The billing component 650 may then inform the payment component 670 that payment was successfully received or processed, and the payment component 670 may credit the account balance of the user who created the assembled video. The payment component 670 may also increment the click and view counts as appropriate. The delivery component 652 may then make the assembled video 660 or portion thereof available to the client viewer 650, e.g., for download or for viewing online.

A representation of an example assembled video 602 is shown in the video storage component 601 of FIG. 6. The video 602 is named Andy's Video and includes three portions. The video 602 is represented by the segment descriptions 664, but is shown as a set of nested rectangles for illustrative purposes. The name of each portion identifies the advertiser that will pay for display of that portion in this example. Note that some users are both advertisers and content providers. For example, Bob and Cindy pay others for views of their videos, but are also paid by advertisers (Donna and Eric in Bob's case, and Fran and Gretchen in Cindy's case). A first portion 604 is named Bob's video, a second portion 615 is named Cindy's video, and a third portion 624 is named Donna's video. The prices (i.e., amounts of payment for display) associated with the portions are shown in the prices table 630 for illustrative purposes (the prices are stored in association with the segment descriptions 664). The prices table 630 shows that each of the three portions of Andy's video 602 is associated with a rights holder and a price. In particular, Andy's video 602 includes Bob's video 604, Cindy's Video 614, and Donna's video 624. Furthermore, Bob's video 604 and Cindy's video 614 each include nested segments. Bob's video 604 includes Donna's video 608 and Eric's video 610. As shown in the prices table 630, the price of Donna's video is $4 and the price of Eric's video is $5. A view of Donna's video by a viewer of Andy's video may result in payment of $4 to Andy's account. In another example, the payment may be split between the creators (or rights holders) of the videos in the nested chain, so that a view of Donna's video by a viewer of Andy's video results in a payment of $2 to Andy's account and $2 to Bob's account. A view of Donna's video by a direct viewer of Bob's video will result in a payment of $4 to Bob's account.

In one example, a nested video such as the video 602 may also be used in the video assembly system 100 so that a rights holder will be paid for uses of their video in accordance with their video's position in the nested hierarchy. For example, if Bob, Donna, and Eric were rights holders offering their videos for display for a fee, and Andy included Bob's video as a portion of an assembled video, then a view of Andy's video would result in payment of prices to Bob, Donna, and Eric. If the prices are specified as fixed quantities (e.g., $1 per view), then the prices may be divided between the rights holders in the nested hierarchy, e.g., the $6 price for Gretchen's video may be divided between Andy and Bob, or Andy and Bob may each pay the $6 price, so that Gretchen would receive $12 per view of Andy's video).

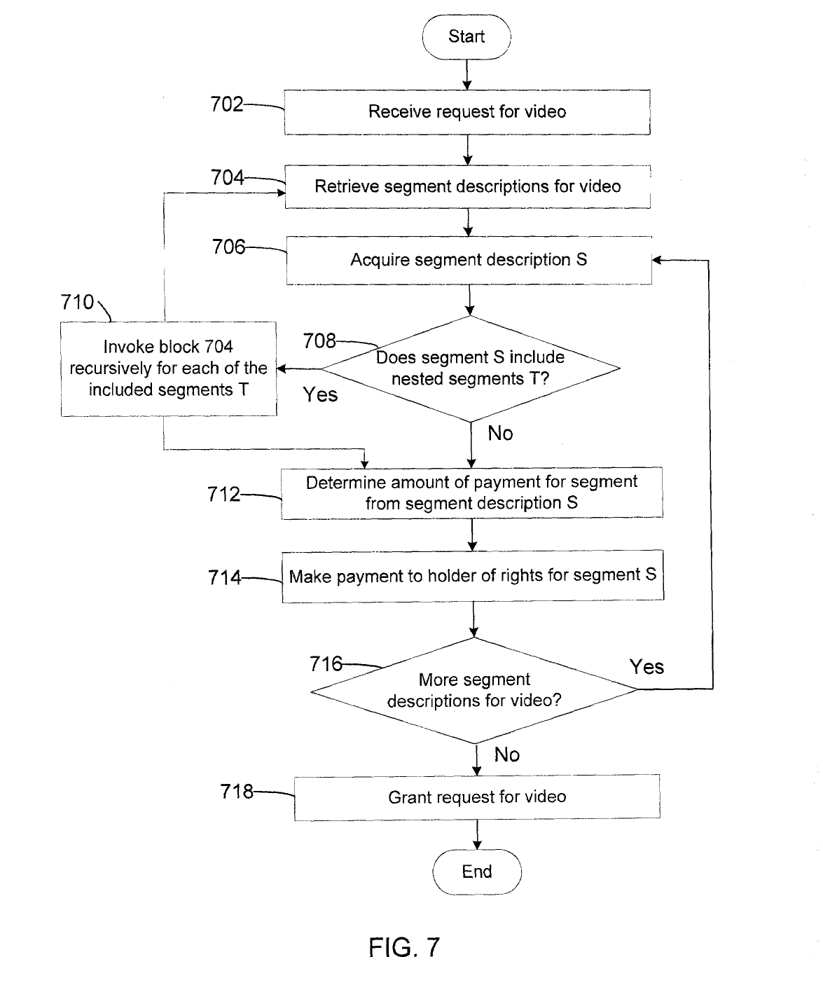

FIG. 7 is an illustrative flow diagram of a process for making payments to rights owners of portions in accordance with embodiments of the invention. The process of FIG. 7 corresponds to the payment component 118 of FIG. 1A and may be provided by, for example, computer program code stored on a computer-readable medium. Block 702 receives a request for an assembled video. Block 704 retrieves segment descriptions for the video. Block 706 acquires a segment description for a segment S. Block 708 determines if the segment S includes nested portions T. If so block 710 invokes the processed recursively starting at block 704 to process each nested portion T (i.e., sub-portion), and then passes control to block 712. If not, execution continues at block 712. Block 712 determines the amount of payment to be made for the portion S, by, for example, retrieving the price associated with S's segment description. Block 714 makes a payment to the holder of rights for portion S by, for example, crediting the holder's account. Block 716 determines if there are more segment descriptions in the assembled video. If so, execution continues at block 706 and the next segment description is processed. If not, the request for the video is granted at block 718, and the process terminates.

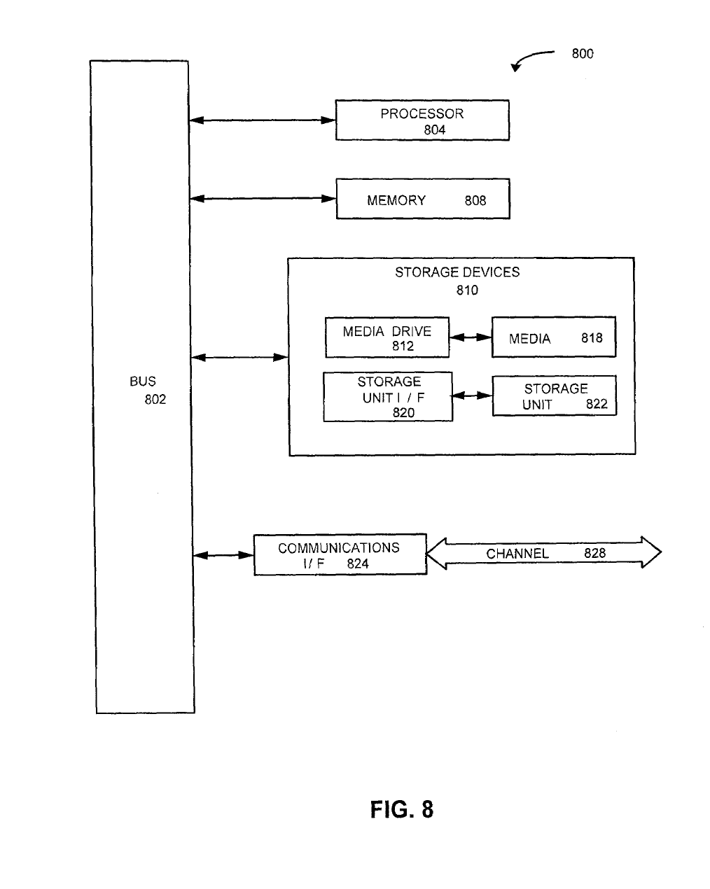

FIG. 8 is an illustrative drawing of an exemplary computer system that may be used in accordance with embodiments of the invention. FIG. 8 illustrates a typical computing system 800 that may be employed to implement processing functionality in embodiments of the invention. Computing systems of this type may be used in clients and servers, for example. Those skilled in the relevant art will also recognize how to implement the invention using other computer systems or architectures. Computing system 800 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communication medium.

Computing system 800 can also include a main memory 808, such as random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus 802 for storing static information and instructions for processor 804.

The computing system 800 may also include information storage system 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 818, may include, for example, a hard disk, floppy disk, magnetic tape, optical disk, CD or DVD, or other fixed or removable medium that is read by and written to by media drive 814. As these examples illustrate, the storage media 818 may include a computer-readable storage medium having stored therein particular computer software or data.

In alternative embodiments, information storage system 810 may include other similar components for allowing computer programs or other instructions or data to be loaded into computing system 800. Such components may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from the removable storage unit 818 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Software and data transferred via communications interface 824 are in the form of signals which can be electronic, electromagnetic, optical or other signals capable of being received by communications interface 824. These signals are provided to communications interface 824 via a channel 828. This channel 828 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 808, storage device 818, or storage unit 822. These and other forms of computer-readable media may be involved in storing one or more instructions for use by processor 804, to cause the processor to perform specified operations. Such instructions, generally referred to as “computer program code” (which may be grouped in the form of computer programs or other groupings), when executed, enable the computing system 800 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by the processor 804, causes the processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

Although only certain exemplary embodiments have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A computer enabled method of assembling at least one section of at least one first media object to form an assembled media object, the method comprising:
receiving at least one segment description that identifies at least one portion of the at least one first media object;
generating an assembled media object that includes the at least one portion; and
providing the assembled media object for subsequent viewing, wherein the at least one segment description is associated with the assembled media object.

2. The method of claim 1, wherein the at least one first media object comprises video, audio, a graphical image, vector graphics animation, an online application, an applet, or a combination thereof.

3. The method of claim 1, wherein the at least one first media object is characterized by a first quality level, further comprising:
generating a preview media object that includes a representation of the at least one portion of the at least one first media object, wherein the preview media object is characterized by a preview quality level, and the preview quality level is lower than the first quality level; and
providing the preview media object for presentation to a user.

4. The method of claim 1, wherein the at least one portion is defined by a start time within the at least one first media object and an end time within the at least one first media object.

5. The method of claim 1, further comprising associating a price with the at least one segment description.

6. The method of claim 5, wherein the assembled media object is associated with a content user, further comprising:
associating the at least one segment description with a content owner, wherein the content owner holds rights to the at least one portion; and
transferring consideration between the content owner and the content user, wherein the amount of consideration is based upon the price associated with the at least one portion.

7. The method of claim 1, wherein the method is provided by a user interface in a web browser.

8. An interface for creating media objects, the interface comprising:
a presentation component for presenting a first media object;
a selection component for selecting at least one portion of the first media object; and
an assembly component for generating an assembled media object, wherein the assembly component is operable to include the at least one portion in the assembled media object at a position specified by a user.

9. The interface of claim 8, further comprising:
a download component for causing the assembled media object to be stored on the user's computer in response to selection by the user of the download component.

10. The interface of claim 8, further comprising:
a payment component for receiving consideration for the assembled media object in response to selection by the user of the purchase component, wherein the amount of the consideration is based upon the at least one portion, and the payment component is operable to transfer the consideration between the user and a content owner, wherein the content owner owns the at least one portion.

11. The interface of claim 10, further comprising:
a download component for causing the assembled media object to be stored on the user's computer in response to receiving the consideration.

12. The interface of claim 10, further comprising:
a purchase component for receiving consideration for rights to the assembled media object in response to selection by the user of the purchase component, wherein the rights entitle a purchaser thereof to use the assembled media object in other media objects.

13. The interface of claim 8, wherein the selection component is operable to receive a start time and an end time of the at least one portion.

14. A computer program product comprising program code for providing an assembled media object to a user wherein the assembled media object comprises at least one portion of a first media object, the program code for:
storing a representation of the assembled media object and associated attributes;
receiving consideration for the at least one portion, wherein the amount of the consideration is based upon a price of the at least one portion;
transferring the consideration to a content owner associated with the at least one portion from a user associated with the assembled media object; and
providing the assembled media object to the user.

15. A computer program product comprising program code for allocating payment for presentation of advertisements in media objects, the program code for:
storing a representation of at least one assembled media object and associated attributes, wherein the at least one assembled media object comprises at least one advertisement portion associated with an advertiser; and
transferring consideration from the advertiser to a first user associated with the at least one assembled media object in response to perception of at least a portion of the advertisement portion by a second user,
wherein the amount of consideration is based upon a price associated with the at least one advertisement portion.

16. The computer program product of claim 15, wherein perception comprises viewing, hearing, selection, or a combination thereof.

17. The computer program product of claim 15, wherein the first user comprises a creator of the at least one assembled media object, a holder of rights to the at least one assembled media object, or a combination thereof.

18. A computer-enabled method of allocating payment to at least one content owner in a media delivery system, the method comprising:
receiving a request for a media object, wherein the media object includes at least one portion, and the at least one portion is associated with a first price and a first content owner;
transferring consideration between a user associated with the media object to the first content owner, wherein the amount of consideration is based upon the first price; and
granting the request for the media object.

19. The computer-enabled method of claim 18, further comprising:
if the at least one portion includes at least one sub-portion, wherein the sub-portion is associated with a second price and a second content owner, transferring consideration between the user associated with the media object and the second content owner, wherein the amount of consideration is based upon the second price.
